(19) United States
(12) Patent Application Publication
(10) Pub. No.: US 2015/0274585 A1
(43) Pub. Date: Oct. 1, 2015

(54) ASYMMETRIC CHEMICAL STRENGTHENING

(71) Applicant: Apple Inc., Cupertino, CA (US)

(72) Inventors: Matthew S. Rogers, San Jose, CA (US); Dale N. Memering, San Francisco, CA (US); Christopher D. Prest, San Francisco, CA (US)

(73) Assignee: Apple Inc., Cupertino, CA (US)

(21) Appl. No.: 14/226,695

(22) Filed: Mar. 26, 2014

(51) Int. Cl. C03C 21/00; G06F 1/16

(52) U.S. Cl. CPC C03C 21/002; G06F 1/1637; G06F 1/1656

(57) ABSTRACT

Apparatus, systems and methods for increasing the strength of glass are disclosed. The strengthening of one portion of the glass article can be performed to a greater degree than another portion. Additionally, to mitigate against any distortion, such as warpage, physical manipulation of the glass article can be performed prior to or during strengthening, namely chemical strengthening. For example, in accordance with one embodiment, an outer surface of a glass article (e.g., cover glass) can be chemically strengthened to a greater degree than an inner surface of the glass article, yet the asymmetric strengthening does not induce distortion of the glass article because the glass article was physically manipulated, such as being bent, to counter any such distortion. Accordingly, glass articles that have undergone chemical strengthening processing are able to be not only thin and undistorted but also sufficiently strong and resistant to damage. The strengthened glass articles are well suited for use in consumer products, such as consumer electronic devices (e.g., portable electronic devices).

### BACKGROUND OF THE INVENTION

Conventionally, some portable electronic devices use glass as a part of their devices, either internal or external. Externally, a glass part can be provided as part of a housing, such a glass part is often referred to as a cover glass. The transparent and scratch-resistance characteristics of glass make it well suited for such applications. Internally, glass parts can be provided to support display technology. For example, a portable electronic device can provide a display technology layer beneath an outer cover glass. A sensing arrangement can also be provided with or adjacent the display technology layer. By way of example, the display technology layer may include or pertain to a Liquid Crystal Display (LCD) that includes a Liquid Crystal Module (LCM). The LCM generally includes an upper glass sheet and a lower glass sheet that sandwiches a liquid crystal layer therebetween. The sensing arrangement may be a touch sensing arrangement such as those used to create a touch screen. For example, a capacitive sensing touch screen can include substantially transparent sensing points or nodes dispersed about a sheet of glass.

Unfortunately, however, use of glass with portable electronic devices requires that the glass be relatively thin. Generally speaking, the thinner the glass the more susceptible the glass is to damage when the portable electronic device is stressed or placed under a significant force. Chemical strengthening has been used to strengthen glass. Conventionally, chemical strengthening has been performed in a symmetric matter, whereby both a top side and a bottom side of a glass part are chemically strengthened at the same time and to the same degree. With symmetric chemical strengthening, the glass piece is uniformly chemically strengthened such that the compressive stress at the top side and the bottom size are balanced. While chemically strengthening is effective, there is a continuing need to provide improved ways to strengthen glass, namely, thin glass.

### SUMMARY

The invention relates generally to increasing the strength of a glass article. The strengthening of one portion of the glass article can be performed to a greater degree than another portion. Additionally, to mitigate against any distortion, such as warpage, physical manipulation of the glass article can be performed prior to or during strengthening, namely chemical strengthening. For example, in accordance with one embodiment, an outer surface of a glass article (e.g., cover glass) can be chemically strengthened to a greater degree than an inner surface of the glass article, yet the asymmetric strengthening does not induce distortion of the glass article because the glass article was physically manipulated, such as being bent, to counter any such distortion. Accordingly, glass articles that have undergone chemical strengthening processing are able to be not only thin and undistorted but also sufficiently strong and resistant to damage. The strengthened glass articles are well suited for use in consumer products, such as consumer electronic devices (e.g., portable electronic devices).

The invention can be implemented in numerous ways, including as a method, system, device, or apparatus. Several embodiments of the invention are discussed below.

As a method for strengthening glass articles, one embodiment can, for example, include at least: obtaining a glass article having an outer side and an inner side; bending the glass article in a first direction; and performing chemical strengthening on the outer side but not the inner side of the glass article, the performing of the chemical strengthening being while the glass article is bent.

As a method for strengthening glass articles, one embodiment can, for example, include at least: obtaining a glass article having an outer side and an inner side; bending the glass article in a first direction; performing chemical strengthening on the outer side of the glass article to a first extent; and performing chemical strengthening on the inner side of the glass article to a second extent or not at all, wherein the second extend is substantially less than the first extent. The performing of the chemical strengthening can also be done while the glass article is bent.

As a method for strengthening glass articles, one embodiment can, for example, include at least: obtaining a glass article having an outer side and an inner side; depositing an ion-exchange barrier on an inner side of the glass article; applying a force to the glass article to bend the glass article in a first direction; placing the glass article in an ion-exchange bath after being bent in the first direction; performing chemical strengthening of the outer side of the glass article while the glass article is within the ion-exchange bath; and thereafter removing the glass article from ion-exchange bath.

As a consumer electronic product, one embodiment can, for example, include at least: a housing having a front surface, a back surface and side surfaces; electrical components provided at least partially internal to the housing, the electrical components including at least a controller, a memory, and a display, the display being provided at or adjacent the front surface of the housing; and a cover glass provided at or over the front surface of the housing such that the cover glass is provided over the display. The cover glass can be chemically strengthened such that an outer, exposed surface of the cover glass is chemically strengthened to a greater extent than an inner, unexposed surface of the cover glass.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a flow diagram of a glass strengthening process according to one embodiment.

FIGS. 2A-2D illustrate processing to chemically strengthened a glass article according to one embodiment.

FIG. 2E illustrates a chemically strengthened glass article after completion of chemical strengthening process according to another embodiment.

FIG. 3 illustrates a glass strengthening system according to one embodiment.

FIG. 4 is a flow diagram of a glass strengthening process according to another embodiment.

FIGS. 5A-5E illustrate processing to chemically strengthened a glass article according to one embodiment.

FIG. 6A is a cross-sectional diagram of a glass cover which has been chemically treated such that a chemically strengthened layer is created according to one embodiment.

FIG. 6B is a cross-sectional diagram of a glass cover which has been chemically treated, as shown to include a chemically treated portion in which potassium ions have been implanted according to one embodiment.

FIG. 7 is a diagrammatic representation of a chemical treatment process that involves submerging a glass cover in an ion bath according to one embodiment.

FIGS. 8A and 8B are diagrammatic representations of electronic device according to one embodiment.

FIGS. 9A and 9B are diagrammatic representations of electronic device according to another embodiment.

### DETAILED DESCRIPTION OF EMBODIMENTS OF THE INVENTION

The invention relates generally to increasing the strength of a glass article. The strengthening of one portion of the glass article can be performed to a greater degree than another portion. Additionally, to mitigate against any distortion, such as warpage, physical manipulation of the glass article can be performed prior to or during strengthening, namely chemical strengthening. For example, in accordance with one embodiment, an outer surface of a glass article (e.g., cover glass) can be chemically strengthened to a greater degree than an inner surface of the glass article, yet the asymmetric strengthening does not induce distortion of the glass article because the glass article was physically maniputed, such as being bent, to counter any such distortion. Accordingly, glass articles that have undergone chemical strengthening processing are able to be not only thin and undistorted but also sufficiently strong and resistant to damage. The strengthened glass articles are well suited for use in consumer products, such as consumer electronic devices (e.g., portable electronic devices).

Embodiments of the invention can relate to apparatus, systems and methods for improving strength of a thin glass member for a consumer product, such as a consumer electronic device. In one embodiment, the glass member may be an outer surface of a consumer electronic device. For example, the glass member may, for example, correspond to a glass cover that helps form part of a display area of the electronic device (i.e., situated in front of a display either as a separate part or integrated within the display). As another example, the glass member may form a part of a housing for the consumer electronic device (e.g., may form an outer surface other than in the display area). In another embodiment, the glass member may be an inner component of a consumer electronic device. For example, the glass member can be a component glass piece of a LCD display provided internal to the housing of the consumer electronic device.

The apparatus, systems and methods for improving strength of thin glass are especially suitable for glass covers or displays (e.g., LCD displays), particularly those assembled in small form factor electronic devices such as handheld electronic devices (e.g., mobile phones, media players, personal digital assistants, remote controls, etc.). The glass can be thin in these small form factor embodiments, such as less than 3 mm, or more particularly between 0.3 and 2.5 mm, or even more particularly between 0.3 and 1.2 mm. The apparatus, systems and methods can also be used for glass covers or displays for other devices including, but not limited to including, relatively larger form factor electronic devices (e.g., portable computers, tablet computers, displays, monitors, televisions, etc.). The glass can also be thin in these larger form factor embodiments, such as less than 5 mm, or more particularly between 0.3 and 3 mm.

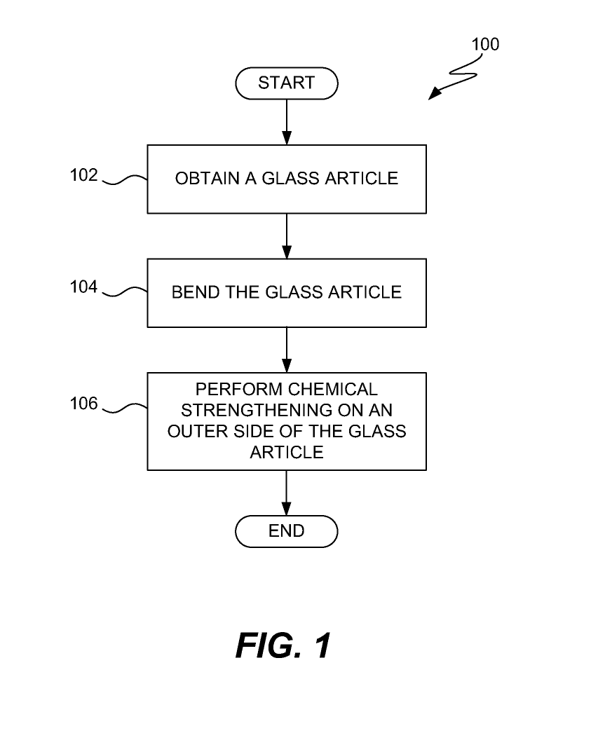

Embodiments of the invention are discussed below with reference to FIGS. 1-8B. However, those skilled in the art will readily appreciate that the detailed description given herein with respect to these figures is for explanatory purposes as the invention extends beyond these limited embodiments. The illustrations provided in these figures are not necessarily drawn to scale; instead, the illustrations are presented in a manner to facilitate presentation.

FIG. 1 is a flow diagram of a glass strengthening process 100 according to one embodiment. The glass strengthening process 100 serves to chemically strengthen a piece of glass such that it is better suited for its particular usage.

The glass strengthening process 100 can obtain 102 a glass article that is to be chemically strengthened. The glass article is then bent 104. In one embodiment, the glass article can be bent 104 by formed (molded, drawn, etc.) to have a curvature. In another embodiment, the glass article can be bent 104 by placing the glass article into an apparatus that induces a bending force onto the glass article to thereby bend the glass article. The degree of bending or curvature is typically relativity small, but may also depend on specific or desired implementation.

After or as the glass article is being bent 104, the glass article can be chemically strengthened 106. In one implementation, the glass can be chemically strengthened 106 through chemical processing. Specifically, the glass can be placed in a potassium solution (i.e., ion-exchange bath) so that potassium ions from the potassium solution can be exchanged for sodium ions within the glass article.

Since the glass article is bent 104 while the glass is being chemically strengthened 106, the glass article can be chemically strengthened 106 in an enhanced manner. More specifically, the chemical strengthening can be primarily or exclusively applied to an outer surface of the glass article. In other words, the outer surface of the glass article is able to become substantially stronger than an inner surface of the glass article that undergoes little or no chemical strengthening. Furthermore, different portions of the outer surface of the glass article may be selectively chemically strengthened or chemically strengthened differently and/or the glass article can be bent in selectively or differently to offset the asymmetric chemical strengthening of the different portions. Consequently, following block 106, the glass article has been chemically strengthened in an asymmetric manner. By bending 104 the glass article, the glass article is able to be chemically strengthened to a greater extent. Following the chemical strengthening 106, the glass strengthening process 100 can end.

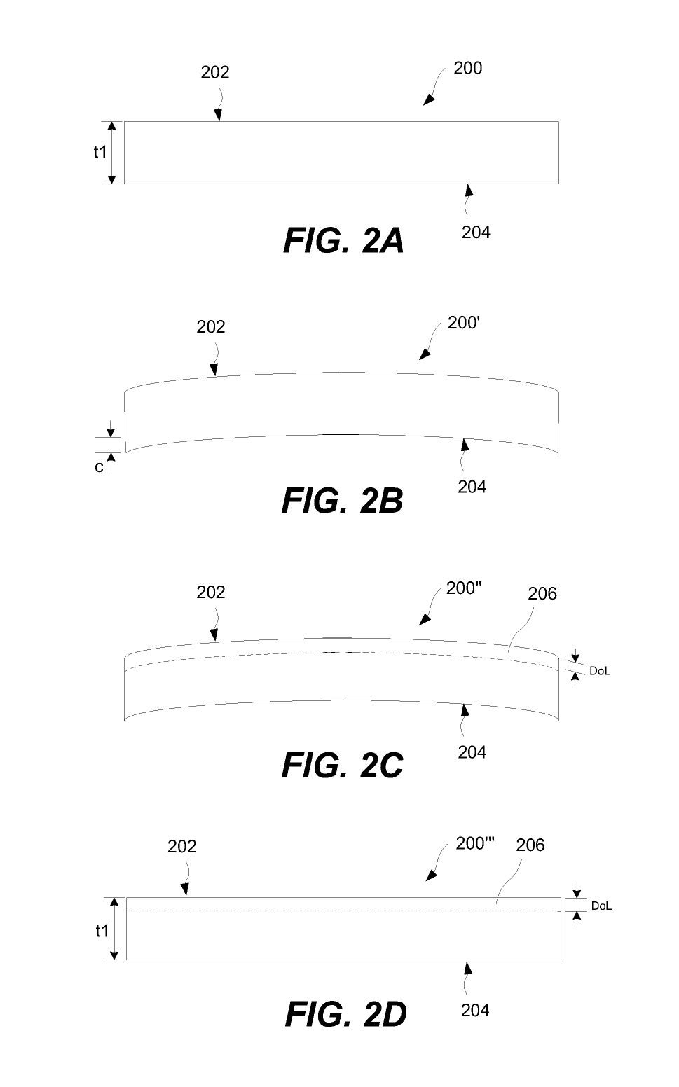

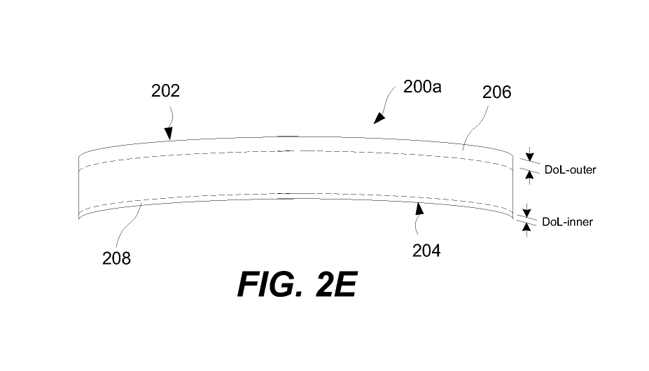

FIGS. 2A-2D illustrate processing to chemically strengthen a glass article 200 according to one embodiment. The processing can correspond to the glass strengthening process 100 illustrated in FIG. 1. In FIG. 2A, the glass article 200 is shown having a thickness t. The thickness t can be generally less than 2 mm and, more particularly, in the range of about 0.2-2.0 mm. The glass article 200 has an outer surface 202 and an inner surface 204.

In FIG. 2B, the glass article 200 shown in FIG. 2A has been bent such that the bent glass article 200′ is curved inward towards the inner surface 204. The bending of the glass article 200 to yield the bent glass article 200′ with a curvature c for the bent glass article 200′. The curvature c is typically relatively small. The glass article 200′ can be bent in a variety of ways. As one example, the glass article 200′ can be formed in a bent matter, such as by allowing a glass sheet to slump in a heated environment to a predetermined curvature. As another example, the glass article 200′ can be bent by an apparatus (e.g., fixture) that imposes a force on the glass article 200′ to induce the bend.

In FIG. 2C, the bent glass article 200′ shown in FIG. 2B undergoes chemically strengthening to yield the chemically strengthened glass article 200″ having a chemically strengthened region 206. Notably, the chemically strengthened region 206 is provided adjacent the outer surface 202 and not adjacent the inner surface 204. As such, the chemically strengthening is primarily, if not exclusively, provided at or adjacent the outer surface 202. As illustrated in FIG. 2C, the chemically strengthened region 206 extends inward from the outer surface 202 to a depth of layer (DoL). Although the DoL can vary with implementation, the DoL is able to be deeper into the glass at the outer surface 202 (while the glass article remains stable, e.g., within frangibility limits) because the DoL is little or non-existent at the inner surface 204, through use of embodiments of the invention. Since an outer layer adjacent the outer surface 202 is chemically strengthened substantially more that an inner layer adjacent the inner surface 204, the chemically strengthened glass article 200″ can be referred to as being asymmetrically chemically strengthened.

FIG. 2D illustrates the chemically strengthened glass article 200′″ after completion of the chemical strengthening process. The chemically strengthened glass article 200′″ shown in FIG. 2D is depicted as planar, or at least substantially planar, following completion of the chemical strengthening process. The completion of the chemical strengthening process can include either removal of the glass article from an apparatus that induced a bend or removal of the glass article from a chemical strengthening bath. The chemical strengthening process increases the compression strength at the outer surface 202 by ion exchange. While this renders the outer surface 202 more resistant to damage (e.g., breakage), since the inner surface 204 is not also being chemically strengthened, then the chemically strengthened glass article 200′″ tends to wrap inward from the outer surface 202—meaning the outer surface 202 compresses and the outer surface 204 expands. In such case, the warpage due to the chemical strengthening of the outer surface 202 but not the inner surface 204 causes the curvature c of the chemically strengthened glass article 200″ to be countered. Consequently, the chemically strengthened glass article 200′″ no longer has its curvature as it had prior to the beginning of the chemical strengthening as the bend glass article 200′ shown in FIG. 2B.

Following such chemical strengthening, depending on the type of glass, the glass article 200′″ having a 1 mm thickness can have a central tension (CT) of about 20-100 MPa (Mega Pascals) at a central portion, a peripheral portion can have a peak compressive stress at the outer surface 202 of about 300-1100 MPa, and the depth of the compressive layer (i.e., depth of layer) can be about 20-150 microns.

Notably, the chemically strengthened region 206 is provided adjacent the outer surface 202 and not adjacent the inner surface 204. As such, the chemically strengthening is primarily, if not exclusively, provided at or adjacent the outer surface 202. As illustrated in FIG. 2C, the chemically strengthened region 206 extends inward from the outer surface 202 to a depth of layer (DoL). Although the DoL can vary with implementation, the DoL is able to be deeper into the glass at the outer surface 202 (while the glass article remains stable, e.g., within frangibility limits) because the DoL is little or non-existent at the inner surface 204, through use of embodiments of the invention. Since an outer layer adjacent the outer surface 202 is chemically strengthened substantially more that an inner layer adjacent the inner surface 204, the chemically strengthened glass article 200″ can be referred to as being asymmetrically chemically strengthened.

As an alternative, FIG. 2E illustrates the chemically strengthened glass article 200″ after completion of the chemical strengthening process. In this alternative embodiment, the inner surface 204 of the bent glass article 200′ shown in FIG. 2B can also be chemically strengthened to yield the chemically strengthened glass article 200a having a chemically strengthened outer region 206 provided at the outer surface 202 and a chemically strengthened inner region 208 provided at the inner surface 204. However, the degree or extent of the chemical strengthening of the inner surface 204 can be substantially less than that of the chemically strengthening applied to the outer surface 202. In other words, the DoL for the inner surface 204 (i.e., DoL-inner) would be substantially less than the DoL for the outer surface 202 (i.e., DoL-outer).

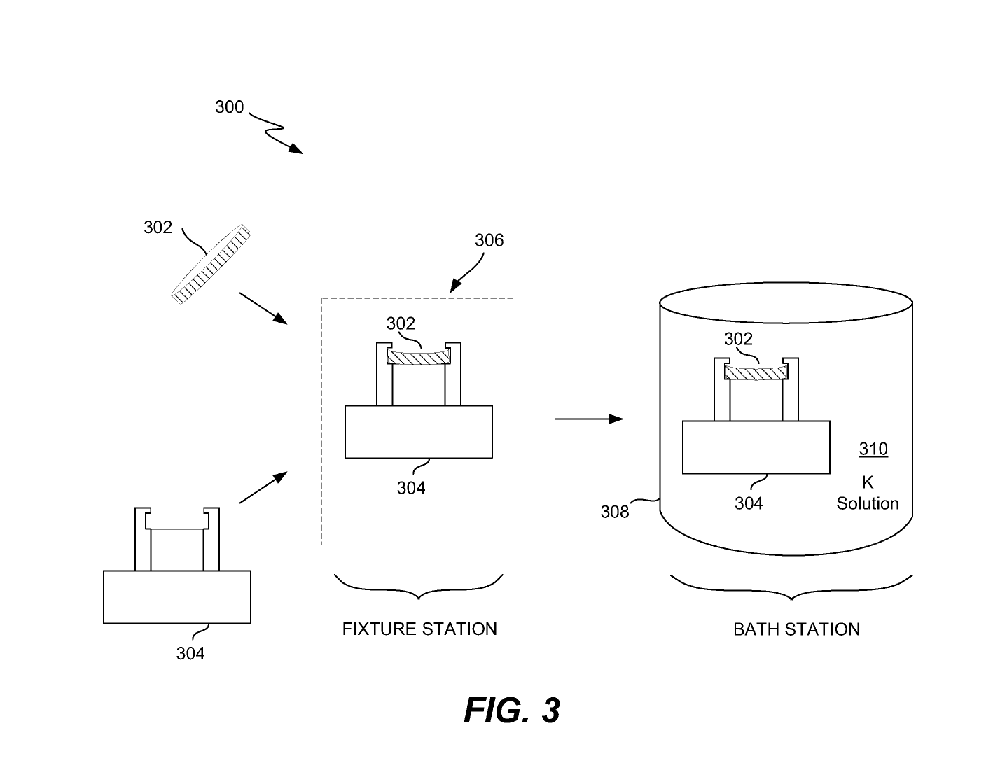

FIG. 3 illustrates a glass strengthening system 300 according to one embodiment. The glass strengthening system 300 receives a glass article 302 to be strengthened through chemical processing. The glass strengthening system 300 also provides a fixture 304. The glass article 302 and the fixture 304 are provided to a fixture station 306. At the fixture station 306, the glass article 302 can be secured by or to the fixture 304. In one implementation, the fixture station 306 is configured to simply secure the glass article 302 to the fixture 304. In another implementation, the fixture station 306 is configured to not only secure the glass article 302 but also to induce a bend to the glass article. The glass article 302 has a bend when in the fixture 304, such as discussed above in FIGS. 1, 2B and 2C, for example.

The fixture 304 having the glass article 302 secured thereto can then be inserted (e.g., immersed) into a bath 308 provided at a bath station. The bath 308 can include an Alkali metal solution, such as a potassium solution 310. At the bath station, ion exchange occurs between the glass article 302 and the potassium solution 310. Later, upon completion of chemical strengthening, the fixture 304 having the glass article 302 can be removed from the bath 308. At this point, the glass article 302 has been chemically strengthened. The effect of the chemical strengthening is not only strengthening of the glass article 302 but also flattening of the bend on the glass article 302. Since the glass article 302 held by the fixture 304 is chemically strengthened in an asymmetric manner, a predetermined side of the glass article 302 is able to be chemically strengthened to a greater extent than would otherwise have been permitted if the glass article were chemically strengthened in a symmetric manner.

Furthermore, following removal of the fixture 304 having the glass article 302 from the bath 308, the glass article 302 can be removed from the fixture 304. Thereafter, to the extent desired, post-processing can be performed on the glass article 302. Post-processing can vary widely dependent on the intended application for the glass article. However, post-processing can, for example, include one or more of rinsing, polishing, annealing and the like.

The potassium solution 310 within the bath 308 can be heated to a predetermined temperature, and the fixture 304 having the glass article 302 can be immersed within the bath 308 for a predetermined period of time. The degree of chemically strengthening provided by the bath 308 to the glass article 302 is dependent on: (1) type of glass, (2) concentration of bath (e.g., K concentration), and (3) time in the bath 308.

In one implementation, the glass for the glass article can, for example, be alumina silicate glass or soda lime glass. Also, it should be noted that glass from different suppliers, even if the same type of glass, can have different properties and thus may require different values. The time for the glass article 302 to remain immersed in the bath 308 can be about 6-20 hours and the temperature for the bath 308 can be about 300-500 degrees Celsius.

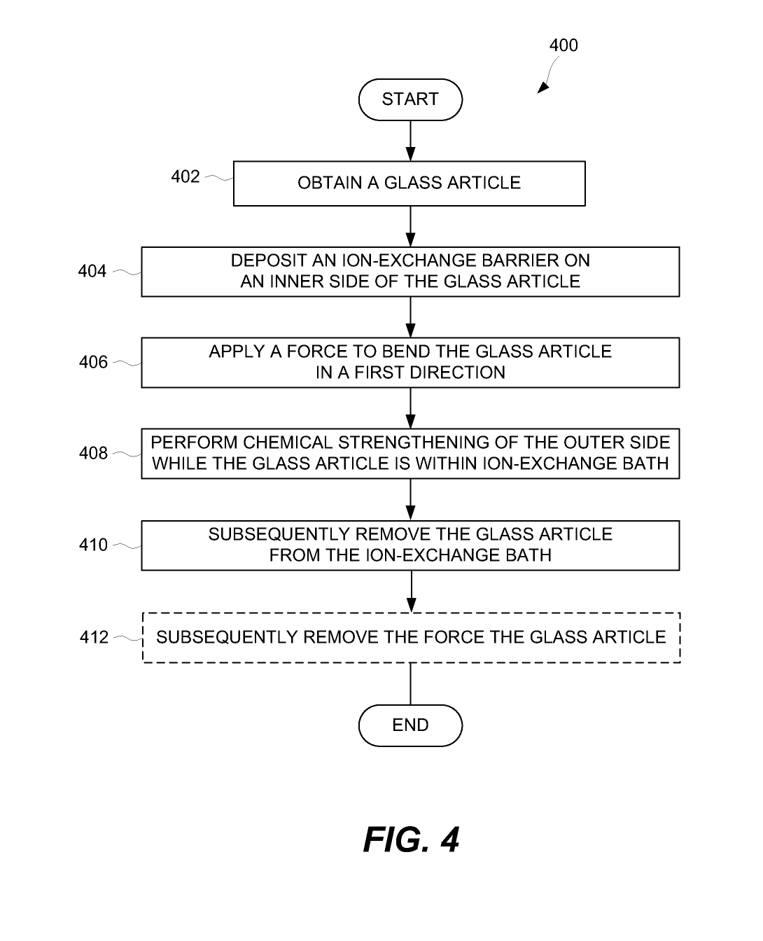

FIG. 4 is a flow diagram of a glass strengthening process 400 according to another embodiment. The glass strengthening process 400 is particularly well-suited for chemically strengthening a glass article in an asymmetric manner. For example, the glass strengthening process 400 can yield a glass article which has different regions (e.g., sides) that are chemically strengthened to a different degree, amount or level. The result is an overall stronger glass article for a particular use.

In this embodiment, the glass article has an outer side and an inner side as primary surfaces. The outer side can also be referred to as a top side, and the inner side can also be referred to as a bottom side. The glass article is normally planar as are the outer side and the inner side.

The glass strengthening process 400 can initially obtain 402 a glass article to be chemically strengthened. Once the glass article has been obtained 402, an ion-exchange barrier can be deposited 404 on an inner side of the glass article. As one example, the ion-exchange barrier can be a layer or thin film of Silicone Nitride (Si₃N₄). As another example, the ion-exchange barrier can be a layer or thin film of Silicone Dioxide (SiO₂). It is typically desired that the ion-exchange barrier be substantially transparent so as to not cause significant optical distortion, particularly when the glass article is to serve as a cover glass over a display device. Other materials can serve as the ion-exchange barrier if transparency is not necessary, such materials can include metal (such as aluminum), polyimide, and the like.

A force to bend the glass article in a first direction can then be applied 406. With the glass article being bent, the glass strengthening process 400 can then perform 408 chemical strengthening of the outer side of the glass article while the glass article is within the ion-exchange bath. Note that since the ion-exchange barrier is on the inner side of the glass article, the chemical strengthening of the inner side is mitigated, or even prevented, by the ion-exchange barrier. Following the completion of the chemical strengthening, the glass article can be removed 410 from the ion-exchange bath and the glass strengthening process 400 can end.

In addition, depending upon the desired implementation, one or more optional operations can be performed. For example, the force can be removed 412 from the glass article. If the force is applied by a fixture that is inserted into the ion-exchange bath, then the force can be removed by removing the glass article from the fixture. Alternatively, if the glass article has been formed into the bent glass article, then the force can be removed after the glass article has been bent because the glass article will remain bent. Following the chemical strengthening 408 and the removal of the force 410 (if any), the glass strengthening process 400 can end.

Additionally, although not shown, additional post-processing can be performed with respect to the glass article. Still further, the glass article can eventually be used in a consumer electronic device, such as a handheld electronic device where the glass article can form, for example, a portion of said outer housing.

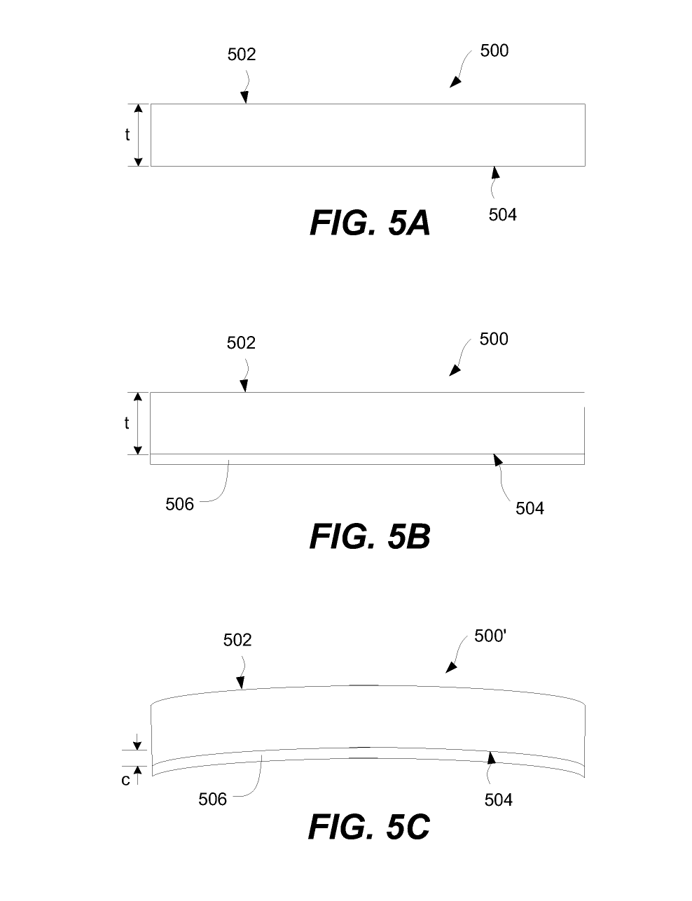

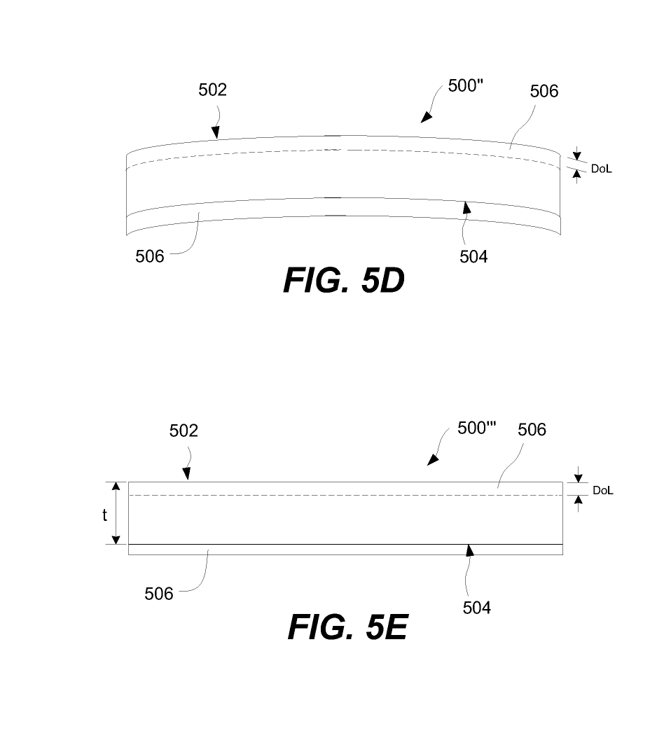

FIGS. 5A-5E illustrate processing to chemically strengthened a glass article 500 according to one embodiment. The processing can correspond to the glass strengthening process 400 illustrated in FIG. 4. In FIG. 5A, the glass article 500 is shown having a thickness t. The thickness t can be generally less than 3 mm and, more particularly, in the range of about 0.1-2.0 mm. The glass article 500 has an outer surface 502 and an inner surface 504.

In FIG. 5B, an ion-exchange barrier 506 is deposited onto the inner surface 504. The ion-exchange barrier 506 is typically thin. For example, the ion-exchange barrier 506 can have a thickness of 5-500 nm. The ion-exchange barrier 506 can be a layer or thin film. For example, the ion-exchange barrier 506 can be formed of Silicone Nitride (Si₃N₄) or Silicone Dioxide (SiO₂). In one embodiment, the ion-exchange barrier can be substantially transparent so as to not cause significant optical distortion. Other materials can serve as the ion-exchange barrier 506 if transparency is not necessary, such materials can include metal (such as aluminum), polyimide, and the like.

In FIG. 5C, the glass article 500 shown in FIG. 5B has been bent such that the bent glass article 500′ is curved inward towards the inner surface 504. The bending of the glass article 500 yields the bent glass article 500′ with a curvature c for the bent glass article 500′. The curvature c is typically relatively small. The glass article 500′ can be bent in a variety of ways. As one example, the glass article 500′ can be formed in a bent matter, such as by allowing a glass sheet to slump in a heated environment to a predetermined curvature. As another example, the glass article 500′ can be bent by an apparatus (e.g., fixture) that imposes a force on the glass article 500′ to induce the bend.

In FIG. 5D, the bent glass article 5200′ shown in FIG. 5C undergoes chemically strengthening to yield the chemically strengthened glass article 500″ having a chemically strengthened region 508. Notably, the chemically strengthened region 508 is provided adjacent the outer surface 502 and not adjacent the inner surface 504. As such, the chemically strengthening is primarily, if not exclusively, provided at or adjacent the outer surface 502. As illustrated in FIG. 5D, the chemically strengthened region 508 extends inward from the outer surface 502 to a depth of layer (DoL). Although the DoL can vary with implementation, the DoL is able to be deeper into the glass at the outer surface 502 (while the glass article remains stable, e.g., within frangibility limits) because the DoL is little or non-existent at the inner surface 504, through use of embodiments of the invention. Furthermore, the outer surface 502 may be selectively chemically strengthened since the glass article. Since an outer layer adjacent the outer surface 502 is chemically strengthened substantially more that an inner layer adjacent the inner surface 504, the chemically strengthened glass article 500″ can be referred to as being asymmetrically chemically strengthened.

FIG. 5E illustrates the chemically strengthened glass article 500′″ after completion of the chemical strengthening process. The chemically strengthened glass article 500′″ shown in FIG. 5E is depicted as planar, or at least substantially planar, following completion of the chemical strengthening process. The completion of the chemical strengthening process can include either removal of the glass article from an apparatus that induced a bend or removal of the glass article from a chemical strengthening bath. The chemical strengthening process increases the compression strength at the outer surface 502 by ion exchange. While this renders the outer surface 502 more resistant to damage (e.g., breakage), since the inner surface 504 is not also being chemically strengthened because it is isolated from ion-exchange by the ion-exchange barrier 506, then the chemically strengthened glass article 500′″ tends to wrap inward from the outer surface 502—meaning the outer surface 502 compresses and the outer surface 504 expands. In such case, the warpage due to the chemical strengthening of the outer surface 502 but not the inner surface 504 causes the curvature c of the chemically strengthened glass article 500″ to be countered. Consequently, the chemically strengthened glass article 500′″ no longer has its curvature as it had prior to the beginning of the chemical strengthening as the bend glass article 500′ shown in FIG. 5C.

Following such chemical strengthening, depending on the type of glass, the glass article 500′″ having a 1 mm thickness can have a central tension (CT) of about 20-100 MPa (Mega Pascals) at a central portion, a peripheral portion can have a peak compressive stress at the outer surface 202 of about 300-1100 MPa, and the depth of the compressive layer (i.e., depth of layer) can be about 20-150 microns.

Following such chemical strengthening, depending on the type of glass, the glass article 500′″ having a 1 mm thickness can have a central tension (CT) of about 20-100 MPa (Mega Pascals) at a central portion, the peripheral portion 808 can have a peak compressive stress at its surface of about 300-1100 MPa, and the depth of the compressive layer (i.e., depth of layer) can be about 20-150 microns. As examples, the glass article 500′″ can be formed of aluminosilicate glass or lithium-aluminosilicate glass. In a more specific embodiment, the glass article 500′″ having a 1 mm thickness can have a central tension (CT) of about 50-60 MPa (Mega Pascals) at a central portion, the peripheral portion 808 can have a peak compressive stress at the surface of about 400-800 MPa, and the depth of the compressive layer (i.e., depth of layer) can be about 50-60 microns for the thick region 802 and about 30-40 microns for the thin region 804.

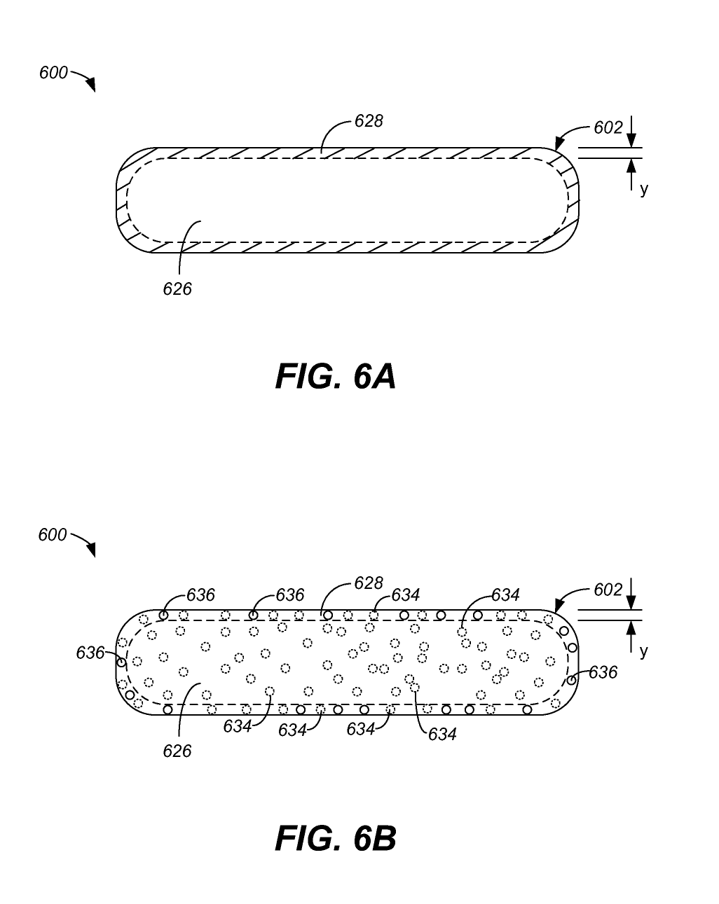

A glass cover which has undergone a chemical strengthening process generally includes a chemically strengthened layer, as previously mentioned. FIG. 6A is a cross-sectional diagram of a glass cover which has been chemically treated such that a chemically strengthened layer is created according to one embodiment. A glass cover 600 includes a chemically strengthened layer 628 and a non-chemically strengthened portion 626. Although the glass cover 600 is, in one embodiment, subjected to chemical strengthening as a whole, the outer surfaces receive the strengthening. The effect of the strengthening is that the non-chemically strengthened portion 626 is in tension, while the chemically strengthened layer 628 is in compression. While glass cover 600 in FIG. 6A is shown as having a rounded edge geometry 602, it should be appreciated that glass cover 600 may generally have any edge geometry, though rounded geometries at edges may allow for increased strengthening of the edges of glass cover 600. Rounded edge geometry 602 is depicted by way of example, and not for purposes of limitation.

FIG. 6B is a cross-sectional diagram of a glass cover which has been chemically treated, as shown to include a chemically treated portion in which potassium ions have been implanted according to one embodiment. Chemically strengthened layer 628 has a thickness (y) which may vary depending upon the requirements of a particular system in which glass cover 600 is to be utilized. Non-chemically strengthened portion 626 generally includes Na⁺ ions 634 but no Alkali metal ions 636. A chemical strengthening process causes chemically strengthened layer 628 to be formed such that chemically strengthened layer 628 includes both Na⁺ ions 634 and Alkali metal ions 636.

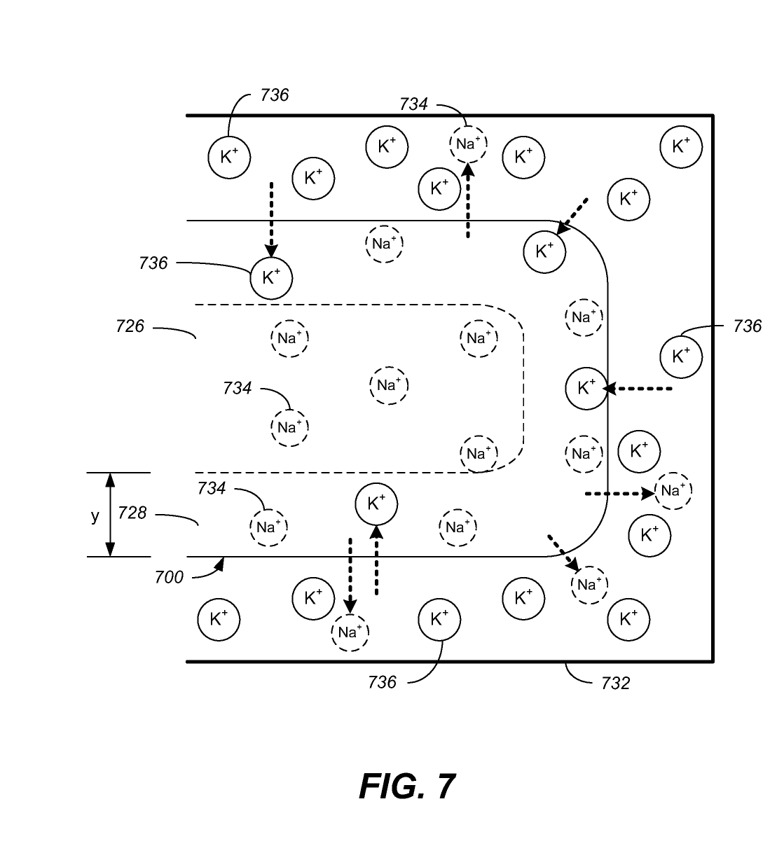

FIG. 7 is a diagrammatic representation of a chemical treatment process that involves submerging a glass cover in an ion bath according to one embodiment. When glass cover 700, which is partially shown in cross-section, is submerged or soaked in a heated ion bath 732, diffusion occurs. As shown, Alkali metal ions 734 which are present in glass cover 700 diffuse into ion bath 732 while Alkali metal ions 736 (e.g., potassium (K)) in ion bath 732 diffuse into glass cover 700, such that a chemically strengthened layer 728 is formed. In other words, Alkali metal ions 736 from ion bath 732 can be exchanged with Na⁺ ions 734 to form chemically strengthened layer 728. Alkali metal ions 736 typically would not diffuse into a center portion 726 of glass cover 700. By controlling the duration (i.e., time) of a chemical strengthening treatment, temperature and/or the concentration of Alkali metal ions 736 in ion bath 732, the thickness (y) of chemically strengthened layer 728 may be substantially controlled.

The concentration of Alkali metal ions in an ion bath may be varied while a glass cover is soaking in the ion bath. In other words, the concentration of Alkali metal ions in an ion bath may be maintained substantially constant, may be increased, and/or may be decreased while a glass cover is submerged in the ion bath without departing from the spirit or the scope of the present invention. For example, as Alkali metal ions displace Na⁺ ions in the glass, the Na⁺ ions become part of the ion bath. Hence, the concentration of Alkali metal ions in the ion bath may change unless additional Alkali metal ions are added into the ion bath.

As previously discussed, glass covers can be used as an outer surface of portions of a housing for electronic devices, such as portable electronic devices. Those portable electronic devices that are small and highly portable can be referred to as handheld electronic devices. A handheld electronic device may, for example, function as a media player, phone, internet browser, email unit or some combination of two or more of such. A handheld electronic device generally includes a housing and a display area.

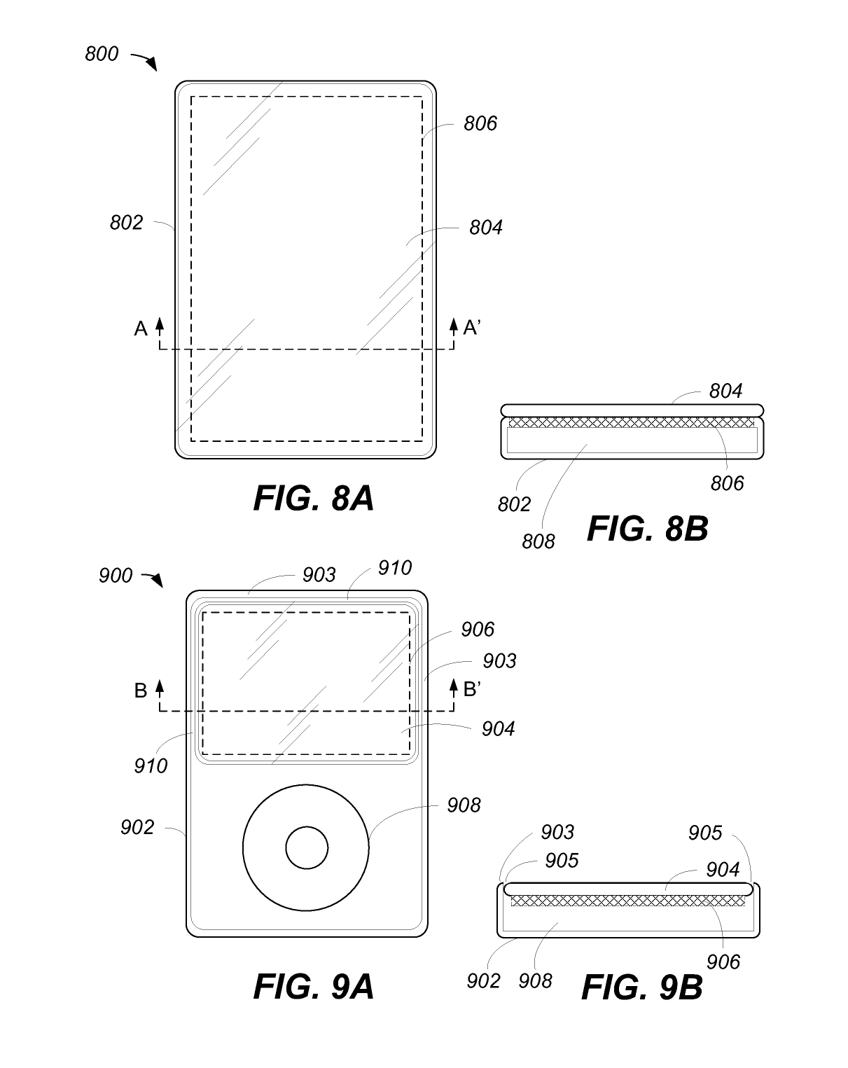

FIGS. 8A and 8B are diagrammatic representations of electronic device 800 according to one embodiment. FIG. 8A illustrates a top view for the electronic device 800, and FIG. 8B illustrates a cross-sectional side view for electronic device 800 with respect to reference line A-A′. Electronic device 800 can include housing 802 that has glass cover window 804 (glass cover) as a top surface. Cover window 804 is primarily transparent so that display assembly 806 is visible through cover window 804. Cover window 804 can be chemically strengthened using the multi-bath chemical processing described herein. Display assembly 806 can, for example, be positioned adjacent cover window 804. Housing 802 can also contain internal electrical components besides the display assembly, such as a controller (processor), memory, communications circuitry, etc. Display assembly 806 can, for example, include a LCD module. By way of example, display assembly 806 may include a Liquid Crystal Display (LCD) that includes a Liquid Crystal Module (LCM). In one embodiment, cover window 804 can be integrally formed with the LCM. Housing 802 can also include an opening 808 for containing the internal electrical components to provide electronic device 800 with electronic capabilities. In one embodiment, housing 802 need not include a bezel for cover window 804. Instead, cover window 804 can extend across the top surface of housing 802 such that the edges of cover window 804 can be aligned (or substantially aligned) with the sides of housing 802. The edges of cover window 804 can remain exposed. Although the edges of cover window 804 can be exposed as shown in FIGS. 8A and 8B, in alternative embodiment, the edges can be further protected. As one example, the edges of cover window 804 can be recessed (horizontally or vertically) from the outer sides of housing 802. As another example, the edges of cover window 804 can be protected by additional material placed around or adjacent the edges of cover window 804.

Cover window 804 may generally be arranged or embodied in a variety of ways. By way of example, cover window 804 may be configured as a protective glass piece that is positioned over an underlying display (e.g., display assembly 806) such as a flat panel display (e.g., LCD) or touch screen display (e.g., LCD and a touch layer). Alternatively, cover window 804 may effectively be integrated with a display, i.e., glass window may be formed as at least a portion of a display. Additionally, cover window 804 may be substantially integrated with a touch sensing device such as a touch layer associated with a touch screen. In some cases, cover window 804 can serve as the outer most layer of the display.

FIGS. 9A and 9B are diagrammatic representations of electronic device 900 according to another embodiment. FIG. 9A illustrates a top view for electronic device 900, and FIG. 9B illustrates a cross-sectional side view for electronic device 900 with respect to reference line B-B′. Electronic device 900 can include housing 902 that has glass cover window 904 (glass cover) as a top surface. In this embodiment, cover window 904 can be protected by side surfaces 903 of housing 902. Here, cover window 904 does not fully extend across the top surface of housing 902; however, the top surface of side surfaces 903 can be adjacent to and aligned vertically with the outer surface of cover window 904. Since the edges of cover window 904 can be rounded for enhanced strength, there may be gaps 905 that are present between side surfaces 903 and the peripheral edges of cover window 904. Gaps 905 are typically very small given that the thickness of cover window 904 is thin (e.g., less than 3 mm). However, if desired, gaps 905 can be filled by a material. The material can be plastic, rubber, metal, etc. The material can conform in gap 905 to render the entire front surface of electronic device 900 flush, even across gaps 905 proximate the peripheral edges of cover window 904. The material filling gaps 905 can be compliant. The material placed in gaps 905 can implement a gasket. By filling the gaps 905, otherwise probably undesired gaps in the housing 902 can be filled or sealed to prevent contamination (e.g., dirt, water) forming in the gaps 905. Although side surfaces 903 can be integral with housing 902, side surface 903 could alternatively be separate from housing 902 and, for example, operate as a bezel for cover window 904.

Cover window 904 is primarily transparent so that display assembly 906 is visible through cover window 904. Display assembly 906 can, for example, be positioned adjacent cover window 904. Housing 902 can also contain internal electrical components besides the display assembly, such as a controller (processor), memory, communications circuitry, etc. Display assembly 906 can, for example, include a LCD module. By way of example, display assembly 906 may include a Liquid Crystal Display (LCD) that includes a Liquid Crystal Module (LCM). In one embodiment, cover window 904 is integrally formed with the LCM. Housing 902 can also include an opening 908 for containing the internal electrical components to provide electronic device 900 with electronic capabilities.

The front surface of electronic device 900 can also include user interface control 908 (e.g., click wheel control). In this embodiment, cover window 904 does not cover the entire front surface of electronic device 900. Electronic device 900 essentially includes a partial display area that covers a portion of the front surface.

Cover window 904 may generally be arranged or embodied in a variety of ways. By way of example, cover window 904 may be configured as a protective glass piece that is positioned over an underlying display (e.g., display assembly 906) such as a flat panel display (e.g., LCD) or touch screen display (e.g., LCD and a touch layer). Alternatively, cover window 904 may effectively be integrated with a display, i.e., glass window may be formed as at least a portion of a display. Additionally, cover window 904 may be substantially integrated with a touch sensing device such as a touch layer associated with a touch screen. In some cases, cover window 904 can serve as the outer most layer of the display.

As noted above, the electronic device can be a handheld electronic device or a portable electronic device. The invention can serve to enable a glass cover to be not only thin but also adequately strong. Since handheld electronic devices and portable electronic devices are mobile, they are potentially subjected to various different impact events and stresses that stationary devices are not subjected to. As such, the invention is well suited for implementation of glass surfaces for handheld electronic device or a portable electronic device that are designed to be thin.

The strengthened glass, e.g., glass covers or cover windows, is particularly useful for thin glass applications. For example, the thickness of a glass cover being strengthened can be between about 0.2-2.5 mm. In other embodiments, the strengthening is suitable for glass products whose thickness is less than about 2 mm, or even thinner than about 1 mm, or still even thinner than about 0.6 mm.

Chemically strengthening glass, e.g., glass covers or cover windows, can be more effective for edges of glass that are rounded by a predetermined edge geometry having a predetermined curvature (or edge radius) of at least 10% of the thickness applied to the corners of the edges of the glass. In other embodiments, the predetermined curvature can be between 20% to 50% of the thickness of the glass. A predetermined curvature of 50% at the edges of the glass can also be considered a continuous curvature.

In one embodiment, the size of the glass cover depends on the size of the associated electronic device. For example, with handheld electronic devices, the size of the glass cover is often not more than five (5) inches (about 12.7 cm) diagonal. As another example, for portable electronic devices, such as smaller portable computers or tablet computers, the size of the glass cover is often between four (4) (about 10.2 cm) to twelve (12) inches (about 30.5 cm) diagonal. As still another example, for portable electronic devices, such as full size portable computers, displays (including televisions) or monitors, the size of the glass cover is often between ten (10) (about 25.4 cm) to twenty (20) inches (about 50.8 cm) diagonal or even larger.

However, it should be appreciated that with larger screen sizes, the thickness of the glass layers may need to be greater. The thickness of the glass layers may need to be increased to maintain planarity of the larger glass layers. While the displays can still remain relatively thin, the minimum thickness can increase with increasing screen size. However, more generally, the thickness of the glass cover can depend on the application and/or the size of electronic device.

As discussed above, glass cover or, more generally, a glass piece may be chemically treated such that surfaces of the glass are effectively strengthened. Through such strengthening, glass pieces can be made stronger so that thinner glass pieces can be used with consumer electronic device. Thinner glass with sufficient strength allows for consumer electronic device to become thinner.

The techniques describe herein may be applied to glass surfaces used by any of a variety of electronic devices including but not limited handheld electronic devices, portable electronic devices and substantially stationary electronic devices. Examples of these include any known consumer electronic device that includes a display. By way of example, and not by way of limitation, the electronic device may correspond to media players, mobile phones (e.g., cellular phones), PDAs, remote controls, notebooks, tablet PCs, monitors, all in one computers and the like.

The various aspects, features, embodiments or implementations of the invention described above can be used alone or in various combinations.

Additional details on strengthening edges of glass articles and/or different chemical baths can be found in: (i) U.S. Provisional Patent Application No. 61/156,803, filed Mar. 2, 2009 and entitled “TECHNIQUES FOR STRENGTHENING GLASS COVERS FOR PORTABLE ELECTRONIC DEVICES”, which is herein incorporated by reference; (ii) International Patent Application No. PCT/US2010/025979, filed Mar. 2, 2010 and entitled “Techniques for Strengthening Glass Covers for Portable Electronic Devices”, which is herein incorporated by reference; (iii) U.S. Provisional Patent Application No. 61/374,988, filed Aug. 18, 2010, and entitled “ENHANCED STRENGTHING OF GLASS”, which is hereby incorporated herein by reference; (iv) U.S. patent application Ser. No. 12/895,823, filed Sep. 30, 2010 and entitled “ENHANCED STRENGTHENING OF GLASS”; (v) U.S. patent application Ser. No. 12/895,372, filed Sep. 30, 2010 and entitled “TECHNIQUES FOR STRENGTHENING GLASS COVERS FOR PORTABLE ELECTRONIC DEVICES”, which is herein incorporated by reference; (vi) U.S. patent application Ser. No. 12/895,393, filed Sep. 30, 2010 and entitled “TECHNIQUES FOR STRENGTHENING GLASS COVERS FOR PORTABLE ELECTRONIC DEVICES”, which is herein incorporated by reference; (vii) U.S. Provisional Patent Application No. 61/301,585, filed Feb. 4, 2010 and entitled “TECHNIQUES FOR STRENGTHENING GLASS COVERS FOR PORTABLE ELECTRONIC DEVICES,” which is hereby incorporated herein by reference; (viii) U.S. patent application Ser. No. 13/107,906, filed May 14, 2011, and entitled “ENHANCED STRENGTHING OF GLASS”, which is hereby incorporated herein by reference; (ix) PCT International Application No. PCT/US2011/023499, filed Feb. 2, 2011, and entitled “ENHANCED CHEMICAL STRENGTHENING GLASS OF COVERS FOR PORTABLE ELECTRONIC DEVICES”, which is hereby incorporated herein by reference; (x) U.S. patent application Ser. No. 12/847,926, filed Jul. 30, 2010, and entitled “ELECTRONIC DEVICE HAVING SELECTIVELY STRENGTHENING GLASS COVER GLASS”, which is hereby incorporated herein by reference; (xi) U.S. Provisional Patent Application No. 61/453,404, filed Mar. 16, 2011, and entitled “ELECTRONIC DEVICE HAVING SELECTIVELY STRENGTHENED GLASS”, which is hereby incorporated herein by reference; (xii) U.S. patent application Ser. No. 13/235,090, filed Sep. 16, 2011, and entitled “ELECTRONIC DEVICE HAVING SELECTIVELY STRENGTHENED GLASS”, which is hereby incorporated herein by reference; and (xiii) U.S. patent application Ser. No. 13/235,036, filed Sep. 16, 2011, and entitled “STRENGTHENING VARIABLE THICKNESS GLASS”, which is hereby incorporated herein by reference.

Although only a few embodiments of the invention have been described, it should be understood that the invention may be embodied in many other specific forms without departing from the spirit or the scope of the present invention. By way of example, the steps associated with the methods of the invention may vary widely. Steps may be added, removed, altered, combined, and reordered without departing from the spirit of the scope of the invention. Similarly, while operations are depicted in the drawings in a particular order, this should not be understood as requiring that such operations be performed in the particular order shown or in sequential order, or that all illustrated operations be performed, to achieve desirable results.

While this specification contains many specifics, these should not be construed as limitations on the scope of the disclosure or of what may be claimed, but rather as descriptions of features specific to particular embodiment of the disclosure. Certain features that are described in the context of separate embodiments can also be implemented in combination. Conversely, various features that are described in the context of a single embodiment can also be implemented in multiple embodiments separately or in any suitable subcombination. Moreover, although features may be described above as acting in certain combinations, one or more features from a claimed combination can in some cases be excised from the combination, and the claimed combination may be directed to a subcombination or variation of a subcombination.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for strengthening glass articles, the method comprising:
obtaining a glass article having an outer side and an inner side;
bending the glass article in a first direction; and
performing chemical strengthening on the outer side but not the inner side of the glass article, the performing of the chemical strengthening being while the glass article is bent.

2. A method as recited in claim 1, wherein following the performing of the chemical strengthening the glass article is substantially planar.

3. A method as recited in claim 1, wherein the following the performing of the chemical strengthening on the outer side of the glass article causes the glass article to produce a force at the outer side that attempts to bend the glass article in a second direction.

4. A method as recited in claim 3, wherein the second direction is opposite to the first direction.

5. A method as recited in claim 1, wherein the performing of the chemical strengthening comprises:
placing a barrier layer on the inner side of the glass article to prevent chemical strengthening of the inner side.

6. A method as recited in claim 5, wherein the barrier layer comprises a thin film.

7. A method as recited in claim 6, wherein the thin film comprises silicon.

8. A method as recited in claim 6, wherein the thin film is substantially transparent.

9. A method as recited in claim 1, wherein the performing of the chemical strengthening comprises:
coupling an apparatus over the inner side of the glass article to prevent chemical strengthening of the inner side.

10. A method as recited in claim 1, wherein the method further comprises:
performing post-processing on the glass article after the performing of the glass strengthening.

11. A method as recited in claim 1, wherein the method further comprises:
subsequently attaching the glass article to a portable electronic device, the glass article serving as a portion of an outer surface of a housing of the portable electronic device.

12. A method as recited in claim 1, wherein the method further comprises:
subsequently utilizing the glass piece in a portable electronic device.

13. A method for strengthening glass articles, the method comprising:
obtaining a glass article having an outer side and an inner side;
bending the glass article in a first direction;
performing chemical strengthening on the outer side of the glass article to a first extent; and
performing chemical strengthening on the inner side of the glass article to a second extent or not at all, wherein the second extend is substantially less than the first extent,
wherein the performing of the chemical strengthening is done while the glass article is bent.

14. A method as recited in claim 13, wherein the performing of the chemical strengthening comprises:
placing a barrier layer on the inner side of the glass article to slow or prevent chemical strengthening of the inner side.

15. A method for strengthening glass articles, the method comprising:
obtaining a glass article having an outer side and an inner side;
depositing an ion-exchange barrier on an inner side of the glass article;
applying a force to the glass article to bend the glass article in a first direction;
placing the glass article in an ion-exchange bath after being bent in the first direction;
performing chemical strengthening of the outer side of the glass article while the glass article is within the ion-exchange bath; and
thereafter removing the glass article from ion-exchange bath.

16. A method as recited in claim 15, wherein the ion-exchange barrier substantially prevents chemical strengthening of the inner side during the performing of the chemical strengthening.

17. A method as recited in claim 15, wherein the performing of the chemical strengthening chemically strengthens the outer side of the glass article such that the outer side has a significantly greater strength than does the inner side.

18. A method as recited in claim 15, wherein the thickness of the glass article is from about 0.3-1.2 mm.

19. A method as recited in claim 18, wherein the method further comprises:
performing post-processing on the glass article following removal of the glass article from the ion-exchange bath.

20. A method as recited in claim 19, wherein the method further comprises:
subsequently attaching the glass article to a portable electronic device, the glass article serving as a portion of an outer surface of a housing of the portable electronic device.

21. A method as recited in claim 15, wherein the method further comprises:
subsequently attaching the glass article to a portable electronic device, the glass article serving as a portion of an outer surface of a housing for the portable electronic device.

22. A method as recited in claim 21, wherein the glass article has a thickness of not more than about three (3) mm.

23. A method as recited in claim 15, wherein the method further comprises:
subsequently removing the force from the glass article.

24. A consumer electronic product, comprising:
a housing having a front surface, a back surface and side surfaces;
electrical components provided at least partially internal to the housing, the electrical components including at least a controller, a memory, and a display, the display being provided at or adjacent the front surface of the housing; and
a cover glass provided at or over the front surface of the housing such that the cover glass is provided over the display, the cover glass being chemically strengthened such that an outer, exposed surface of the cover glass is chemically strengthened to a greater extent than an inner, unexposed surface of the cover glass.

25. A consumer electronic product as recited in claim 24, wherein the outer, exposed surface of the cover glass is chemically strengthened to a depth of layer that is substantially greater than a depth of layer for chemical strengthening of the inner, unexposed surface, if any.

26. A consumer electronic product as recited in claim 25, wherein the thickness of the cover glass is from about 0.3-1.2 mm.
